(19) United States
(12) Patent Application Publication
(10) Pub. No.: US 2010/0307789 A1
(43) Pub. Date: Dec. 9, 2010

(54) CORD

(75) Inventor: Kiyotaka Sakai, Shinagawa-ku (JP)

Correspondence Address: MERCHANT & GOULD PC, P.O. BOX 2903, MINNEAPOLIS, MN, 55402-0903, US

(73) Assignee: SDK Company Limited, Shinagawa-ku (JP)

(21) Appl. No.: 12/560,291

(22) Filed: Sep. 15, 2009

(30) Foreign Application Priority Data
Jun. 8, 2009 (JP) 2009-137088

(51) Int. Cl. H01B 7/36

(52) U.S. Cl. 174/112

(57) ABSTRACT

The cord has a flexible reinforcing core wire. The reinforcing core wire is formed of one or a plurality of reinforcing fibers such as aramid fibers. A plurality of (for example, three) insulated conductors are twisted together around the reinforcing core wire. The insulated conductors are respectively colored into different colors to be distinguished from each other, and include a plurality of insulated wires twisted together. Each of the insulated wires is formed of a polyurethane copper wire or the like whose conductor is insulation-coated with resin. An insulating outer coating member coats the periphery of the reinforcing core wire and the three insulated conductors. The insulating outer coating member has a substantially circular tube shape in section, and is formed of soft synthetic resin. Accordingly, the cord is reduced in diameter and weight.

### BACKGROUND ART

1. Field of the Invention

The present invention relates to a cord for connecting headphones, earphones, a microphone, earphones with a microphone and the like to a portable audio device, a mobile phone and the like.

2. Description of the Related Art

FIG. 1 is a perspective view illustrating a conventional cord disclosed in Japanese Patent Laid-Open Nos. 2008-10328 and 2008-269799, for example.

The cord is a three wire cord. The cord includes three insulated conductors 10 (=10-1 to 10-3), and an insulating outer coating member 20 which coats the insulated conductors 10. Each of the insulated conductors 10 includes a reinforcing fiber 11 having flexibility, and a plurality of (for example, 14) insulated wires 12 which are twisted around the reinforcing fiber 11. Each of the insulated wires 12 is formed of a polyurethane copper wire or the like whose conductor (having a conductor diameter of 0.006 mm, for example) is insulation-coated with resin.

For example, stereo headphones and the like are connected to one end of the three wire cord, and a plug is connected to the other end thereof. The plug is inserted into a receptacle that is provided in a portable audio device and the like, thereby electrically connecting the stereo headphones and the portable audio device through the cord.

In the conventional cord as shown in FIG. 1, there is an advantage that the cord has a large mechanical strength against bending, tension or the like since the reinforcing fiber 11 is provided in each of the three insulated conductors 10-1 to 10-3. However, it is difficult to reduce the diameter of the cord, and as the number of insulated conductors is increased, the cord has a larger diameter and is increased in weight.

### SUMMARY OF THE INVENTION

It is a first object of the present invention to provide a cord which can be reduced in cord diameter and weight while increasing its mechanical strength against bending, tension or the like, and can further prevent polarity errors in use.

It is a second object of the present invention to provide a cord which can achieve the first object and can be also used for various purposes.

In order to achieve the first object, a cord according to a first invention includes: a reinforcing core wire having flexibility; a plurality of insulated conductors twisted together around the reinforcing core wire; and an insulating outer coating member for coating the plurality of insulated conductors. The insulated conductors respectively have a plurality of insulated wires twisted together, and are distinguished from each other by different colors.

In order to achieve the first object, a cord according to a second invention is the cord according to the first invention, further including: a plurality of fixed portions obtained by peeling off an end portion of the outer coating member by a predetermined length to expose an end portion of the reinforcing core wire and end portions of the plurality of insulated conductors, and bundling and fixing each of the end portions of the plurality of exposed insulated conductors by molten metal; a fastening portion for fastening the plurality of exposed insulated conductors by using the exposed reinforcing core wire; and a fixing member for inwardly tightening a periphery of the end portion of the outer coating member.

In order to achieve the second object, a cord according to a third invention includes: a first cord; a second cord arranged along the first cord; and an insulating outer coating member for coating the first and second cords. The first cord includes a reinforcing core wire having flexibility, and a plurality of insulated conductors twisted together around the reinforcing core wire. The insulated conductors respectively have a plurality of insulated wires twisted together, and are distinguished from each other by different colors. The second cord includes a conductor core wire, an insulating inner coating member for coating the conductor core wire, and a shield formed with insulated wires being wrapped around the inner coating member.

With the cord according to the first and second inventions, since the plurality of insulated conductors are twisted together around the reinforcing core wire as described above, the mechanical strength against bending, tension or the like can be increased, and the cord can be reduced in diameter and weight. Furthermore, since the insulated conductors are distinguished from each other by different colors, polarity errors can be prevented when the cord is connected to earphones and the like.

With the cord according to the third invention, the plurality of insulated conductors are twisted together around the reinforcing core wire in the first cord as described above. Therefore, the mechanical strength against bending, tension or the like can be increased, and the cord can be reduced in diameter and weight. Furthermore, since the cord has the second cord, the cord can be used for various purposes.

The above and other objects and novel features of the present invention will become more apparent from the following detailed description of the preferred embodiments when considered in conjunction with the accompanying drawings. Note that the following drawings are only intended for illustration purposes and not to limit the scope of the present invention.

### BRIEF DESCRIPTION OF THE DRAWINGS

FIG. 1 is a perspective view illustrating a conventional cord;

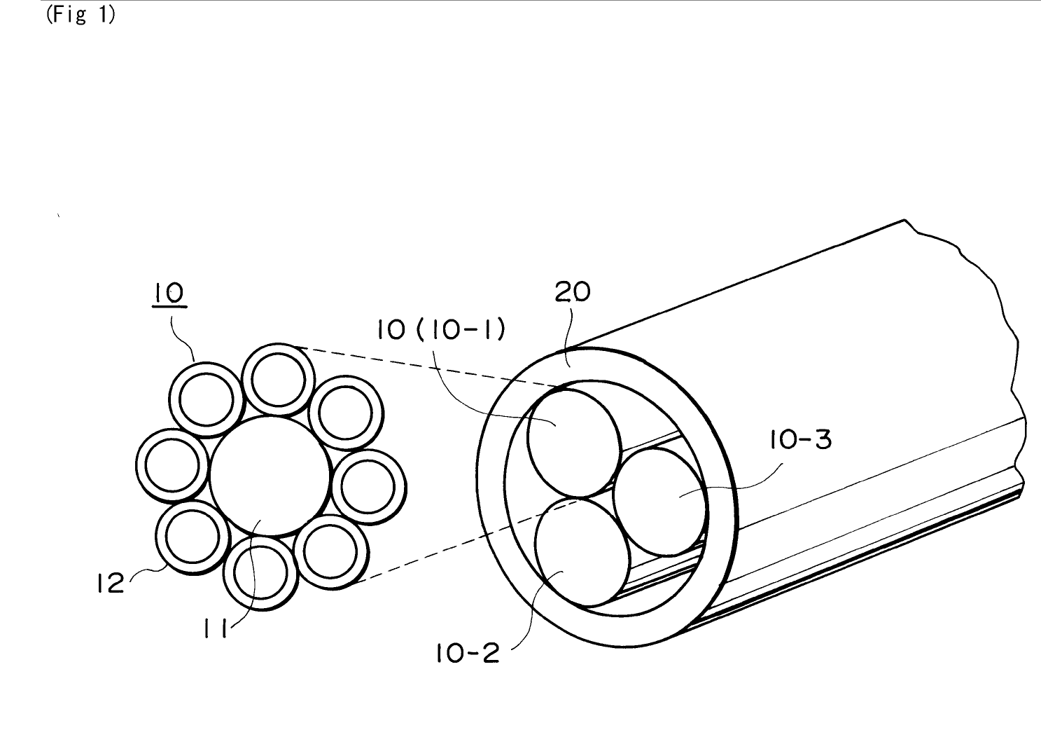

FIG. 2 is a perspective view illustrating a cord according to an embodiment 1 of the present invention;

FIG. 3 is a perspective view illustrating the end portion of the cord shown in FIG. 2; and

FIG. 4 is a sectional view illustrating a cord according to an embodiment 2 of the present invention.

### DESCRIPTION OF THE PREFERRED EMBODIMENTS

In the following, embodiments of the present invention will be described with reference to the accompanying drawings.

### Embodiment 1

### (Configuration of Cord According to Embodiment 1)

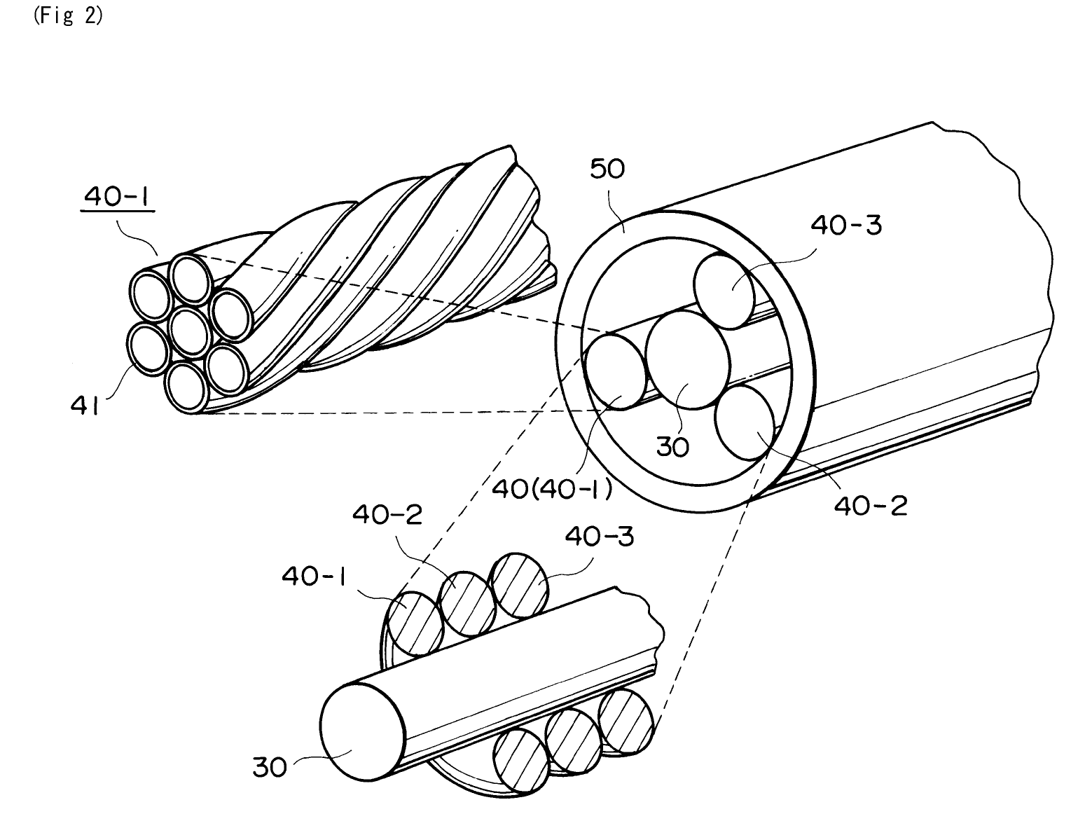

FIG. 2 is a perspective view illustrating a cord according to an embodiment 1 of the present invention.

The cord is a three wire cord having a cord diameter of about 1 mm, for example, for connecting headphones, earphones, a microphone, earphones with a microphone and the like to a portable audio device, a mobile phone and the like. The cord has a reinforcing core wire 30 having flexibility. The reinforcing core wire 30 is formed of one or a plurality of reinforcing fibers such as aramid fibers (having a diameter of about 0.1 mm, for example). A plurality of (for example, three) insulated conductors 40 (=40-1 to 40-3) are twisted together around the reinforcing core wire 30. The plurality of insulated conductors 40 are respectively colored into different colors (for example, three colors: a transparent color that is the self color, green, and red) so as to be distinguished from each other. Each of the insulated conductors 40 is formed with a plurality of (for example, 14) insulated wires 41 being twisted together.

Each of the insulated wires 41 is formed of a polyurethane copper wire whose conductor (having a conductor diameter of 0.006 mm, for example) is insulation-coated with resin.

The insulated wires 41 respectively forming the insulated conductors 40-1, 40-2 and 40-3 may have a different conductor diameter in each of the insulated conductors 40-1, 40-2 and 40-3. For example, the insulated conductor 40-1 which is colored into a transparent color that is the self color may be formed of insulated wires having a conductor diameter of 0.008 mm. The insulated conductor 40-2 which is colored into green may be formed of insulated wires having a conductor diameter of 0.005 mm. The insulated conductor 40-3 which is colored into red may be formed of insulated wires having a conductor diameter of 0.006 mm. By making the conductor diameters of the insulated wires 41 different as described above, the insulated conductors 40-1, 40-2 and 40-3 can be easily separated from each other (that is, sorted from each other) when the end portion of the cord is processed.

An insulating outer coating member 50 coats the periphery of the reinforcing core wire 30 and the three insulated conductors 40-1 to 40-3. The insulating outer coating member 50 has a substantially circular tube shape in section, and is formed of soft synthetic resin (for example, polyvinyl chloride (PVC)).

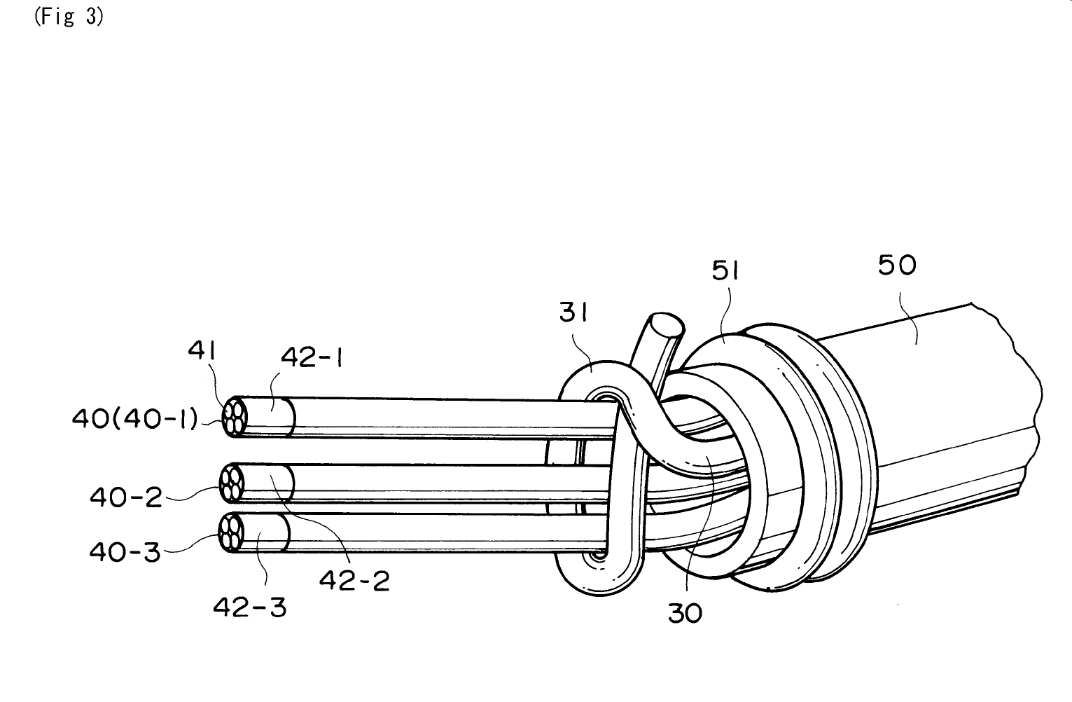

FIG. 3 is a perspective view illustrating the end portion of the cord shown in FIG. 2.

The end portion of the outer coating member 50 of the cord shown in FIG. 2 is peeled off by a predetermined length to expose the end portion of the reinforcing core wire 30 and the end portions of the three insulated conductors 40-1 to 40-3. Each of the end portions of the three exposed insulated conductors 40-1 to 40-3 is bundled and fixed by molten metal (for example, solder) to form fixed portions 42-1 to 42-3. The plurality of insulated wires 41 constituting each of the insulated conductors 40-1 to 40-3 are thereby prevented from being separated from each other.

The exposed reinforcing core wire 30 is tied around the three exposed insulated conductors 40-1 to 40-3 to fasten the three insulated conductors 40-1 to 40-3. The three insulated conductors 40-1 to 40-3 are bundled together by the fastening portion 31. The periphery of the end portion of the outer coating member 50 is tightened inwardly by a fixing member 51. The outer coating member 50, the reinforcing core wire 30, and the insulated conductors 40-1 to 40-3 are thereby bound together. The fixing member 51 is formed of an annular fitting or the like.

### (Production Example of Cord According to Embodiment 1)

When the three wire cord shown in FIG. 2 is produced, the plurality of insulated wires 41 are twisted together by a buncher, for example, to form each of the insulated conductors 40. The three insulated conductors 40-1 to 40-3 are then reeled onto a drum. The three insulated conductors 40-1 to 40-3 reeled onto the drum are reeled out. The three insulated conductors 40-1 to 40-3 are twisted together with a predetermined distance therebetween around the reinforcing core wire 30, and are reeled onto the drum. The reinforcing core wire 30 and the insulated conductors 40-1 to 40-3 reeled onto the drum are reeled out, and are coated with the outer coating member 50 by an extruder. The reinforcing core wire 30 and the insulated conductors 40-1 to 40-3 coated with the outer coating member 50 are reeled onto the drum, thereby completing the production of the three wire cord shown in FIG. 2.

When the cord produced as described above is used, the cord is cut into a predetermined length depending on the intended use. As shown in FIG. 3, the both end portions of the outer coating member 50 of the cord, which has been cut into a predetermined length, are cut by use of a cutting jig such as a heating wire. The cut end portions of the outer coating member 50 are peeled off, to expose the both end portions of the reinforcing core wire 30 and the both end portions of each of the three insulated conductors 40 (=40-1 to 40-3) by a predetermined length. The both end portions of each of the three exposed insulated conductors 40 having different colors are respectively bundled and fixed by molten metal such as solder, to form the fixed portions 42-1 to 42-3. The both end portions of the insulated wires 41 constituting each of the insulated conductors 40 are thereby prevented from being separated from each other.

Furthermore, the exposed reinforcing core wire 30 is tied around the three exposed insulated conductors 40-1 to 40-3 to fasten the three insulated conductors 40-1 to 40-3. The three insulated conductors 40-1 to 40-3 are bundled together by the fastening portion 31. Subsequently, the peripheries of the both end portions of the outer coating member 50 are tightened inwardly by the fixing members 51 by using a tightening jig or the like. The outer coating member 50, the reinforcing core wire 30, and the insulated conductors 40-1 to 40-3 are thereby bound together, so that the three wire cord having an end structure as shown in FIG. 3 is obtained.

When the cord having a predetermined length processed as described above is connected to headphones, a plug and the like, the vicinity of the fixing member 51 is mechanically fixed to the headphones, and the fixed portions 42-1 to 42-3 of the three insulated conductors 40-1 to 40-3 are connected to the electrode terminals of the headphones. Accordingly, electric signals can be transmitted to the headphones through the cord.

### (Advantage of Embodiment 1)

Such advantages as described in the following (1) and (2) can be obtained according to the embodiment 1.

(1) The three insulated conductors 40-1 to 40-3 respectively have the insulated wires simply twisted together without providing a reinforcing core wire in each of the insulated conductors 40-1 to 40-3, and are twisted together around the common reinforcing core wire 30. Therefore, the insulated conductors 40-1 to 40-3 have the same electrical characteristics such as impedance as those of each other. Furthermore, the mechanical strength against bending, tension or the like is increased, and the cord can be reduced in diameter and weight. Since the insulated conductors 40-1 to 40-3 are distinguished from each other by different colors, polarity errors can be prevented when the cord is connected to earphones and the like.

(2) The end portion of the reinforcing core wire 30 is tied around the end portions of the three insulated conductors 40-1 to 40-3 to fasten the three insulated conductors 40-1 to 40-3, and the periphery of the end portion of the outer coating member 50 is tightened inwardly by the fixing member 51. Therefore, the outer coating member 50, the reinforcing core wire 30, and the insulated conductors 40-1 to 40-3 can be rigidly bound together.

### Embodiment 2

### (Configuration of Cord According to Embodiment 2)

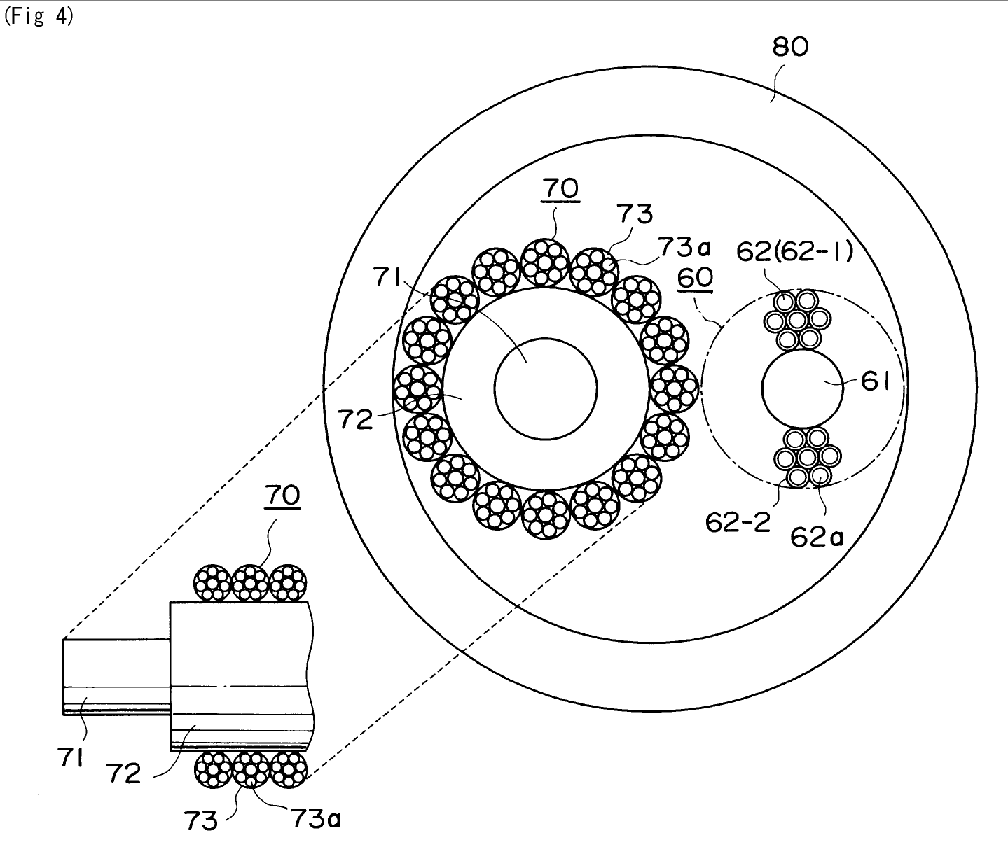

FIG. 4 is a sectional view illustrating a cord according to an embodiment 2 of the present invention.

The cord according to the embodiment 2 is a cord having a cord diameter of about 1.7 mm, for example, for connecting earphones with a microphone and the like to a portable audio device, a mobile phone and the like. The cord includes a two wire first cord 60 and a coaxial second cord 70 arranged along the first cord 60. The first and second cords 60 and 70 are coated with an insulating outer coating member 80. The insulating outer coating member 80 has a substantially circular tube shape in section, and is formed of soft synthetic resin (for example, PVC).

The first cord 60 includes a reinforcing core wire 61 having flexibility that is similar to the reinforcing core wire 30 of the embodiment 1, and a plurality of (for example, two) insulated conductors 62 (=62-1 and 62-2) twisted together around the reinforcing core wire 61 in a similar manner to the insulated conductors 40 of the embodiment 1. The insulated conductors 62 (=62-1 and 62-2) respectively have a plurality of (for example, 14) insulated wires 62a twisted together, and are distinguished from each other by different colors in a similar manner to the insulated conductors 40 of the embodiment 1.

The second cord 70 includes a conductor core wire 71 that is formed of a metal wire such as a copper wire. The conductor core wire 71 is coated with an insulating inner coating member 72 such as nylon. The inner coating member 72 has a circular tube shape in section. A bunch of insulated wires 73a similar to the insulated wires 62a is spirally wrapped around the inner coating member 72, thereby forming a spiral shield 73.

### (Production Example of Cord According to Embodiment 2)

When the cord shown in FIG. 4 is produced, the plurality of insulated wires 62a are twisted together by a buncher, for example, to form each of the insulated conductors 62-1 and 62-2. The two insulated conductors 62-1 and 62-2 are then reeled onto a drum. The two insulated conductors 62-1 and 62-2 reeled onto the drum are reeled out. The two insulated conductors 62-1 and 62-2 are twisted together with a predetermined distance therebetween around the reinforcing core wire 61, thereby forming the first cord 60. The first cord 60 is then reeled onto the drum.

Also, the conductor core wire 71 reeled onto the drum is reeled out. The conductor core wire 71 is coated with the inner coating member 72 by an extruder, and is reeled onto the drum. The inner coating member 72 reeled onto the drum is reeled out. The spiral shield 73 is mounted on the inner coating member 72 by spirally wrapping the bunch of insulated wires 73a around the inner coating member 72, thereby forming the second cord 70. The second cord 70 is reeled onto the drum.

Subsequently, the first and second cords 60 and 70 reeled onto the drum are reeled out, and are coated with the outer coating member 80 by an extruder. The first and second cords 60 and 70 coated with the outer coating member 80 are reeled onto the drum, thereby completing the production of the cord shown in FIG. 4.

When the cord produced as described above is used, the cord is cut into a predetermined length depending on the intended use in a similar manner to the embodiment 1 although not shown in the drawings, and is processed as described below, for example.

In the cord shown in FIG. 4, the end portion of the outer coating member 80 is peeled off by a predetermined length, to expose the end portions of the first and second cords 60 and 70. Each of the end portions of the two insulated conductors 62-1 and 62-2 of the exposed first cord 60 is bundled and fixed by molten metal (for example, solder), to form fixed portions. The plurality of insulated wires 62a constituting each of the insulated conductors 62-1 and 62-2 are thereby prevented from being separated from each other. Furthermore, the exposed reinforcing core wire 61 is tied around the two exposed insulated conductors 62-1 and 62-2 to fasten the two insulated conductors 62-1 and 62-2. The two insulated conductors 62-1 and 62-2 are bundled together by the fastening portion.

In the exposed second cord 70, the end portion of the bunch of insulated wires 73a constituting the spiral shield 73 is preferably bundled and fixed by molten metal such as solder in order to prevent the insulated wires 73a from being separated from each other.

Subsequently, the periphery of the end portion of the outer coating member 80 is tightened inwardly by a fixing member such as an annular fitting. The outer coating member 80, and the first and second cords 60 and 70 are thereby bound together.

In the cord having a predetermined length processed as described above, for example, the first cord 60 can be connected to earphones, headphones and the like to receive an audio signal, and the second cord 70 can be connected to a microphone and the like to transmit an audio signal.

### (Advantage of Embodiment 2)

Such advantages as described in the following (1) to (3) can be obtained according to the embodiment 2.

(1) In the first cord 60, the two insulated conductors 62-1 and 62-2 respectively have the insulated wires simply twisted together without providing a reinforcing core wire in each of the insulated conductors 62-1 and 62-2, and are twisted together around the common reinforcing core wire 61, as in the embodiment 1. Therefore, the insulated conductors 62-1 and 62-2 have the same electrical characteristics such as impedance as those of each other. Furthermore, the mechanical strength against bending, tension or the like is increased, and the cord can be reduced in diameter and weight. Since the insulated conductors 62-1 and 62-2 are distinguished from each other by different colors, polarity errors can be prevented when the cord is connected to earphones and the like.

(2) The end portion of the reinforcing core wire 61 is tied around the end portions of the two insulated conductors 62-1 and 62-2 to fasten the two insulated conductors 62-1 and 62-2, and the periphery of the end portion of the outer coating member 80 is tightened inwardly by the fixing member (not shown). Therefore, the outer coating member 80, the first and second cords 60 and 70 can be rigidly bound together.

(3) Since the cord includes the coaxial second cord 70 in addition to the first cord 60, the cord can be used for various purposes. For example, the first cord 60 can be used for receiving an audio signal, and the second cord 70 can be used for transmitting an audio signal from a microphone and the like.

### (Modification)

The present invention is not limited to the aforementioned embodiments 1 and 2, and may be variously used or modified. The usage and modification examples include the following (a) to (c), for example.

(a) The number of the insulated conductors 40-1 to 40-3 in FIG. 2 is not limited to three, and may be changed to another number such as two, four, five and six. The insulated conductors may be accordingly colored into different colors (for example, a transparent color that is the self color, green, red, and other colors) so as to be distinguished from each other. Similarly, the number of the insulated conductors 62-1 and 62-2 of the first cord 60 shown in FIG. 4 is not limited to two, and may be changed to another number such as three, four, five and six. The insulated conductors may be accordingly colored into different colors so as to be distinguished from each other. The material, sectional shape and conductor diameter of each of the insulated wires 41 and 62a constituting the insulated conductors 40 (=40-1 to 40-3) and 62 (=62-1 and 62-2) may be changed to the ones other than those in the embodiments 1 and 2.

(b) In the second cord 70 shown in FIG. 4, a braid shield obtained by braiding the insulated wires 73a may be provided instead of the spiral shield 73.

(c) The sectional structure, dimensions, material, production method or the like of each of the cords shown in FIGS. 2 and 4 are not limited to the ones described in the embodiment 1 and 2, and various changes may be made therein.

1. A cord comprising:
a reinforcing core wire having flexibility;
a plurality of insulated conductors twisted together around the reinforcing core wire; and
an insulating outer coating member for coating the plurality of insulated conductors,
wherein the insulated conductors respectively have a plurality of insulated wires twisted together, and are distinguished from each other by different colors.

2. The cord according to claim 1, further comprising:
a plurality of fixed portions obtained by peeling off an end portion of the outer coating member by a predetermined length to expose an end portion of the reinforcing core wire and end portions of the plurality of insulated conductors, and bundling and fixing each of the end portions of the plurality of exposed insulated conductors by molten metal;
a fastening portion for fastening the plurality of exposed insulated conductors by using the exposed reinforcing core wire; and
a fixing member for inwardly tightening a periphery of the end portion of the outer coating member.

3. A cord comprising:
a first cord;
a second cord arranged along the first cord; and
an insulating outer coating member for coating the first and second cords,
wherein the first cord comprises a reinforcing core wire having flexibility, and a plurality of insulated conductors twisted together around the reinforcing core wire,
the insulated conductors respectively having a plurality of insulated wires twisted together, and being distinguished from each other by different colors, and
the second cord comprises a conductor core wire, an insulating inner coating member for coating the conductor core wire, and a shield formed with insulated wires being wrapped around the inner coating member.

4. The cord according to claim 1, wherein the reinforcing core wire is formed of one or a plurality of reinforcing fibers.

5. The cord according to claim 1, wherein each of the insulated wires is a synthetic enamel wire including a polyurethane copper wire.

6. The cord according to claim 1, wherein the outer coating member is formed of soft synthetic resin.

7. The cord according to claim 2, wherein the fixing member is an annular fitting.
